(19) United States
(12) Patent Application Publication
(10) Pub. No.: US 2012/0008774 A1
(43) Pub. Date: Jan. 12, 2012

(54) Method and device to enhance video content

(75) Inventors: André Kudelski, Lutry (CH); Christophe Nicolas, St. Prex. (CH)

(73) Assignee: Nagravision S.A., Cheseaux-sur-Lausanne (CH)

(21) Appl. No.: 13/067,920

(22) Filed: Jul. 7, 2011

Related U.S. Application Data
(60) Provisional application No. 61/364,836, filed on Jul. 16, 2010.

(30) Foreign Application Priority Data
Jul. 8, 2010 (EP) 10168949.5
Nov. 12, 2010 (EP) 10191105.5

(51) Int. Cl. H04N 5/445; H04N 7/167; H04N 11/02

(52) U.S. Cl. 380/236; 348/563; 348/384.1; 348/E05.099; 348/E11.006

(57) ABSTRACT

A multifunction device for television set and a method to enhance video content provided to a display device of said television set. The multifunction device comprises an input for receiving audio/video data from an audio/video content data source, an output for outputting audio/video data to the display device, and communication means for accessing Internet or a local area network for collecting additional data. The multifunction device being connected and powered by a common interface of the display device further comprises image processing means configured for receiving first image data from the input, a converter configured for receiving additional data from Internet or a local area network and for converting said additional data into additional image data, an image merging module configured for combining said additional image data with all or part of the input first image data to obtain second image data to be forwarded to the output connected to the display device.

### CROSS REFERENCE TO RELATED APPLICATIONS

This application claims priority under 35 U.S.C. Section. 119 to U.S. Provisional Application NO. 61/364,836, entitled “Multifunction device for television” filed Jul. 16, 2010, European Patent Application No 10168949.5 filed Jul. 8, 2010 and European Patent Application No 10191105.5 filed Nov. 12, 2010, the entire contents of each of the aforementioned documents being hereby incorporated herein by reference.

### INTRODUCTION

Today's television sets are no longer limited to display only broadcast programs. The users are willing to use the television screen to access the almost infinite resources provided by the Internet. However, the majority of already sold television sets is not equipped with Internet access and is unable to take advantage of these resources.

### TECHNICAL BACKGROUND

A solution was proposed in form of an external device connected at one side to the Internet via an Ethernet or a WiFi interface, and at the other side to an output providing data in a suitable format to a television set, for example a format according to HDMI (High-Definition Multimedia Interface) standard. This known external device has its own remote control, power supply and cable and tend to complicate and to clutter up the space around the television set.

Further solutions have been developed for accessing content provided by several sources such as:

Document EP2026558A1 discloses a module for supplying a transport stream to a digital television decoder apparatus. The module capable of receiving transport streams comprising multiplexed packets containing video and audio signals, comprises a packet multiplexer arranged to multiplex packets containing application data generated in the module into a received transport stream; and a transport stream interface capable of connection to a digital television decoder apparatus and of supplying a transport stream to the digital television decoder apparatus. The module is configured to supply a transport stream output from the packet multiplexer to the transport stream interface.

The module further includes a controller arranged to control the operation of the module which is capable of receiving commands indicating user-inputs. The controller is arranged to generate the application data for providing an on-screen display and to control the operation of the module in response to the commands, so as to implement a man-machine interface. According to an embodiment, the transport stream interface includes a connector in accordance either with DVB-CI standard, or PCMCIA standard or USB standard. According to a further embodiment, the module comprises a network interface for receiving data over a data network which may be a wired or a wireless network of type IP respectively WLAN. The module may also include a decryption circuit arranged to perform decryption of the received transport stream.

A converter circuit arranged to perform transcoding of the received transport stream from an encoding in accordance with a first encoding scheme into an encoding in accordance with a second, different encoding scheme may be provided as option. For example the module converts a MPEG-4 stream into a MPEG-2 stream or a HD video into a SD video stream

Document: US2008/250462A1 discloses an apparatus for connecting a multimedia portable electronic device capable of storing and playing and/or recording video in digital form, to at least one other electronic device. The apparatus comprises an interface for establishing continuity of at least one signal between said apparatus and the portable electronic device and/or for transferring energy to the portable electronic device; and at least one interface for establishing continuity of at least one signal between said apparatus and the at least one other electronic device; and at least one wireless communications interface; and means for implementing at least one function involving all or some of the resources implemented in said apparatus. Means to create an image on the display device resulting from a mixture of data provided by a broadcast channel and data collected from Internet are not included in the apparatus.

Document: US2008/0148335A1 describes an accessory device to be connected to a television receiver. The accessory device may be any associated television including, for example, a personal video recorder (PVR), an IPTV (Internet Protocol Television) module, a disc player, or other peripheral device such as devices that permit storage of information on flash memory. The television device may be connected to the accessory device be utilizing a common interface represented as video and command accessory interface such as HDMI, USB, IEEE 1394 or Ethernet. A PCMCIA interface connector capable of carrying video, power and command data may also be used as interface. The accessory device comprises a processor and a display generator that generates information passed across the interface to display interface. According to an embodiment, the accessory device further comprises a memory storing an application carried out at the accessory device along with a command processor handling commands passed from the television device to the accessory device. The latter does not include communication means necessary for accessing Internet or a local area network for collecting additional data to be combined with received audio video data.

### BRIEF DESCRIPTION OF THE INVENTION

An aim of the present invention is to provide a compact multifunction device for receiving audio/video content and additional data from an external network to be combined with the audio/video data and forwarded directly to a television set.

This aim is achieved by a multifunction device for television set to enhance video content comprising an input for receiving audio/video data from an audio/video content data source, an output for outputting audio/video data to a display device, and communication means for accessing Internet or a local area network for collecting additional data, the multifunction device being connected and powered by a common interface of the display device is characterized in that it further comprises image processing means configured for receiving first image data from the input, a converter configured for receiving additional data from Internet or a local area network and for converting said additional data into additional image data, an image merging module configured for combining said image additional data with all or part of the input first image data to obtain second image data to be forwarded to the output connected to the display device.

A further object of the present invention is a method for enhancing video content transmitted from an audio/video content data source to a television set via a multifunction device comprising an input for receiving audio/video data from an audio/video content data source, an output for outputting audio/video data to a display device, communication means for accessing Internet or a local area network for collecting additional data, and a common interface powering and connecting the multifunction device to the display device, the method is characterized in that it comprises step of:
receiving at the input of the multifunction device first image data,
receiving additional data from Internet or a local area network by an image merging module of said multifunction device,
converting the additional data into additional image data,
combining said additional image data with all or part of the first image data to obtain second image data,
forwarding the second image data to the output connected to the display device.

The television set comprises mainly a receiver and inputs for receiving audio/video data from various sources, audio/video data processing means and a display device. The multifunction device is directly connected to the television set through a common interface compliant with CI+ standard incorporated in the housing of the television set. No cable is thus required to transport signals as well as to power the multifunction device. The input of the multifunction device receives audio/video data from an appropriate source, and the output transmits modified video or image data to a video input of the television set included in a HDMI interface for example. The input video data are modified thanks to a combination of the source audio/video data with data originating from the Internet or a local network.

Image data are defined here as comprising non-compressed data including frames and raw picture data able to form images on a screen of the display device.

### BRIEF DESCRIPTION OF THE FIGURES

The invention will be better understood with the following detailed description, which refers to the attached figures given as non-limitative examples.

FIG. 1 shows a schematic overview a multifunction device connected to a television set via a common interface.

FIG. 2 shows a block schematic with modules for carrying out merging operations inside the multifunction device on input first image data and converted additional data issued from an external network to obtain second image data.

FIG. 3 shows an embodiment of the multifunction device of FIG. 2 with an input converter for converting the input image data into image data compatible with the merging module.

### DETAILED DESCRIPTION OF THE INVENTION

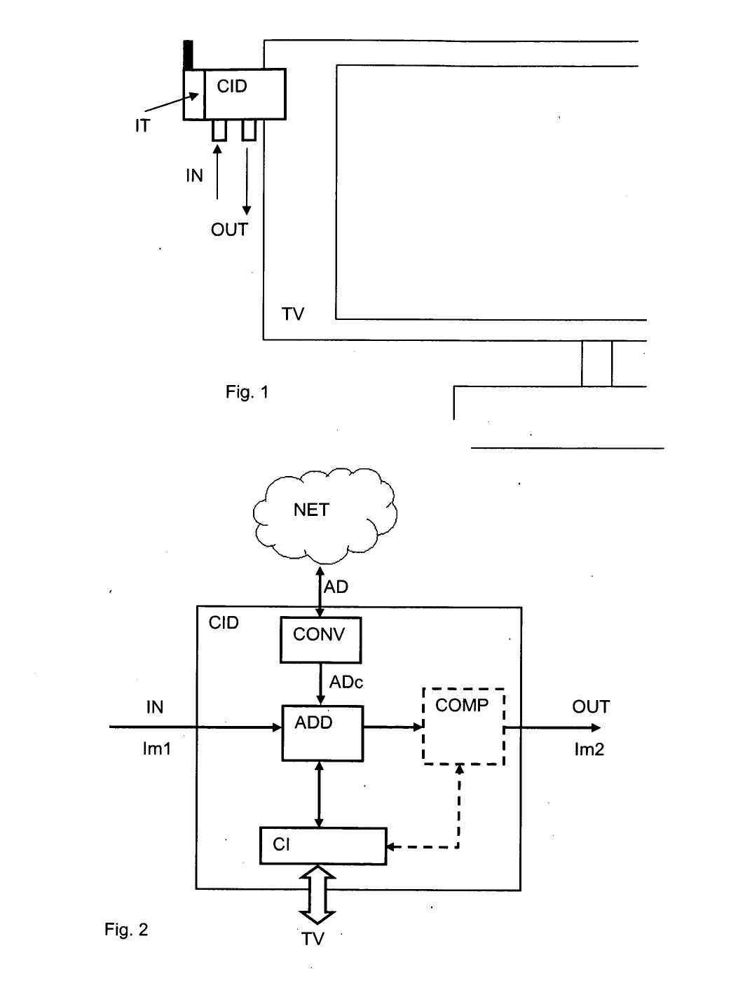

The FIG. 1 illustrates the multifunction device CID of the invention connected to the standard CI+ interface which is present on most of the television sets. The power is taken from the television set to supply the various circuits within the multifunction device. This multifunction device comprises three main connections. The first one is the Internet interface IT. In the example illustrated by FIG. 1, the multifunction device comprises a wireless interface. However, this interface can be also an Ethernet (wired) connection (e.g. TCP/IP protocol) or a power-line (PLC). This interface allows gathering information from the Internet resources such as video products which may be downloaded and displayed on the display device thanks to this interface.

The multifunction device comprises a second connection which is an input for audio/video data. This input is generally connected to a video source such as a DVD player, a set-top-box, a PVR, a game set, a computer i.e. any device that produces audio/video data to be displayed. One of the formats generally used is the HDMI but the present invention is not limited to this interface and can also comprise other image data formats.

The third connection is directed to the display device, and the audio/video data processed by the multifunction device are outputted toward the display device. The format used can be HDMI or any suitable video format.

The multifunction device comprises mainly three modes: the pass through mode, the overlay mode and the Internet/Network mode.
In the pass-through mode, the audio/video data entering into the multifunction device are simply outputted to the output of said device without modification.
In the overlay mode, the input data in HDMI format for example is processed to form a first image Im1 which correspond with the image received by this input IN, the processing circuits collect information from the Internet to create a second image Im2,the first and the second image are merged in a single image and this resulting image is sent to the output OUT.

According to a preferred embodiment, illustrated by FIG. 2, first image data Im1 generally not compressed enter via the input IN of the multifunction device into an image merging module ADD which combines or merges this first image data Im1 with additional data gathered from Internet or fro a local network. The merging operation is made on additional image data (ADc) having a format similar to the one of the input first image data (Im1). The additional data (AD) originating from a network source are transmitted with a specific format generally compressed using a protocol such as IP protocol are not compatible with the input image data format. Therefore, a conversion of the additional data (AD) becomes necessary before merging operation. This conversion is made by a conversion module CONV arranged between the network data input interface and the merging module ADD. The operation merging is thus performed on image data that are compatible each other, either fully automatically according to predefined program instructions, functions and/or parameters implemented in the image merging module ADD or, in most of the cases, upon user commands and instructions acting on the behavior of the program.

The second image data Im2 thus obtained are forwarded to the output OUT of the multifunction device which is connected to an audio video input of the display device.

The image data (Im1) at the input (IN), the converted additional image data (ADc) and the image data (Im2) obtained at the output of the merging module (ADD) comprise non-compressed data including frames and raw picture data structured in such a way to form images on a screen of the display device.

Optionally the second image data Im2 may be compressed by an image compression module COMP before output to the display device.

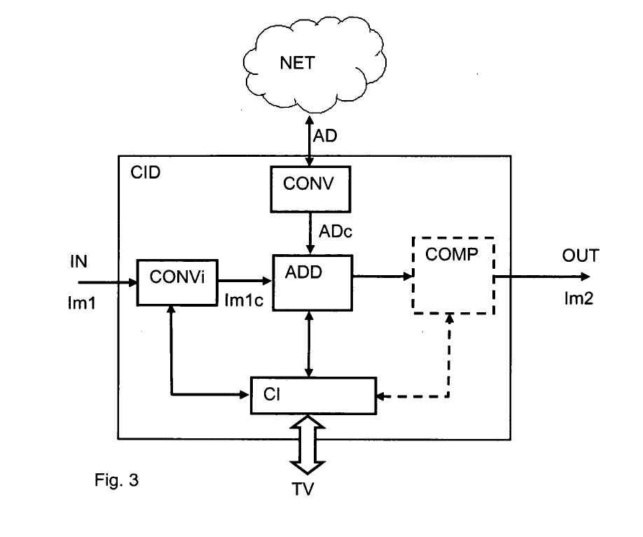

According an embodiment represented by FIG. 3, the multifunction device may further comprise an input converter CONVi configured for receiving first image data (Im1) from the audio/video content data source and for converting said first image data (Im1) into image data (Im1c) having a format compatible with the image merging module (ADD). The input converter CONVi may be adapted to the format of the source data which may be compressed or not compressed but in a format defined by another standard than the one expected for image data entering the merging module ADD. The input converter CONVi may also filter the input image data to obtain only the image data to be transformed by the merging module into final output image data (Im2). The task of merging module ADD is thus reduced and merging operation speed increased since it processes image data Im1c and ADc that are converted into similar formats coming on one hand from the input converter (CONVi) and on the other hand from the conversion module (CONV).

It is to be noted that the merging operation performed by the image merging module ADD can take different forms, such as a superposition of images from the audio/video source and images from Internet, or each image takes a specific area of the full image display format, for example picture in picture mode, split screen, 3D-multi screen selection, etc.).

According to an example, the input audio video data may correspond to degraded or to low resolution images which may be modified to obtain standard or high resolution image data thanks to additional data collected from Internet or other network provider. A conditional control system may authorize access to the additional data also called control objects only if the user has purchased the necessary rights at the provider. Otherwise, the multifunction module acts in pass through mode by ignoring the additional data, the user watching thus low resolution images instead of high quality HD images.

According to a further example the input audio video data may be watermarked with patterns provided by a server on Internet before entering into the display device. The watermark is then used as identification and copy protection of the source image data.

According to a further example the source audio/video data may comprise subtitles in a given language which may be translated automatically in real time in another language thanks to an on-line translator made available on Internet. The image merging module (ADD) replaces the original language subtitles with the new language subtitle before forwarding to the output (OUT). Other data may be searched automatically or manually on Internet related or not to the input image data such as additional information to be displayed in superimposition or in a particular area of the image (top or bottom margins for example). Information such as stock exchange rates, short news or any special event information may be displayed in this way together with the source audio/video data.
In the Internet/Network mode, the data outputted to the output OUT are resulting of the data collected via Internet or the local area network. The data coming from the input IN are ignored and only the data AD collected from Internet and converted into image data ADc are sent to the output.

In a further embodiment, the Internet interface is connected to a hub (or a local network) allowing accessing Internet as well as neighbor devices connected to the local network. Consequently, the audio/video source as described above, transmits the audio/video data through the hub and then to the Internet interface of the multifunction device.

The display device is controlled by a single remote control which is the same than the one controlling the television set. One particularity of the CI+ interface (Common Interface Plus) is to reroute the remote control user's commands received by the display device. The multifunction device comprises a command input to receive the user's commands allowing various actions in response to the received commands.

These commands can serve to specify the data collected via Internet (e.g. download a widget, access a weather forecast site), or to organize the data collected via Internet in view of the incoming audio/video input. This can be in the form of moving to the left corner a widget, activating it or defining a window with the Internet data and a different window with the incoming audio/video input.

In a further embodiment, these commands are then sent to the video source via the Internet interface. The video source can then reacts to the commands sent by the user as long as these commands refer to the video source. This is the case if the video source is a receiver/decoder in charge of receiving broadcast audio/video data (free to air or conditional access data). In this case the display device plays the role of a monitor only and the selection of the channels is made directly by the receiver/decoder. The multifunction device thus relays the commands up to the receiver/decoder. A single remote control can then control the display device as well as the receiver/decoder.

Several commands can be directed for the management of the multifunction device. This is the case for selecting one of the three modes (pass-through, overlay or Internet) or selecting the size of each window in the overlay mode. In case of accessing Internet data, the remote control can plays the role of a keyboard. The command sent by the remote control are received by the display device and then passed to the multifunction device. While accessing Internet, these commands allow the selection of web site, enter search criteria etc.

According to an embodiment of the invention, the receiver/decoder and the multifunction device share common secret keys to secure the communication between both devices. The output of the receiver/decoder is further encrypted according to this secret key and the multifunction device decrypts the encrypted audio/video data with the secret key stored in a memory of the multifunction device before passing the audio/video data thus decrypted to the merging module ADD. The secure connection between the receiver/decoder and the multifunction device creates a mating between both devices and only these two devices can work together.

The initialization of the secret keys can be done through various ways:
the multifunction device is locally connected with the receiver/decoder to exchange keys. The receiver/decoder comprises a CI+ connector for that purpose. The generated keys are then stored in a memory on both receiver/decoder and multifunction device.
The multifunction device detects the presence of the receiver/decoder and obtains an identification of same. The multifunction device then sends a message to a management center requesting the initialization with the receiver/decoder, this message comprising the identification of the receiver/decoder and the identification of the multifunction device. In return, the management center sends a message, pertaining to the multifunction device and encrypted by a personal key of said device. The message contains the secret keys needed to communicate with the receiver/decoder. The receiver/decoder takes the same action with the identification of the multifunction device and its identification, and receives the initialization message. Both multifunction device and receiver/decoder are ready to communicate.

1. A multifunction device for television set to enhance video content comprising an input for receiving audio/video data from an audio/video content data source, an output for outputting audio/video data to a display device, and communication means for accessing Internet or a local area network for collecting additional data, the multifunction device being connected and powered by a common interface of the display device further comprises image processing means configured for receiving first image data from the input, a converter configured for receiving additional data from Internet or a local area network and for converting said additional data into additional image data, an image merging module configured for combining said additional image data with all or part of the input first image data to obtain second image data to be forwarded to the output connected to the display device.

2. The multifunction device according to claim 1, wherein the image data comprise non-compressed data including frames and raw picture data ready to form images on a screen of the display device.

3. The multifunction device according to claim 2, wherein the communication means for accessing Internet or a local area network are wireless.

4. The multifunction device according to claim 2, wherein the communication means for accessing Internet or a local area network is an Ethernet network interface.

5. The multifunction device according to claim 2, further comprising an image compression module configured for compressing the second image data before forwarding to the output.

6. The multifunction device according to claim 2, wherein the common interface with the display device comprises a command input, said command input receiving user's commands sent by a user to the display device and forwarded to the multifunction device.

7. The multifunction device according to claim 6, wherein the user's commands allow defining the data collected via Internet.

8. The multifunction device according to claim 6, wherein the user's commands allow defining the part of the first image into the second image.

9. The multifunction device according to claim 2, further comprising storage and decryption means, the decryption means acting on the audio/video data entering at the input to produce decrypted audio/video data, said decryption means receiving and using a secret key stored in the storage means.

10. The multifunction device according to claim 2, wherein the input and output are of the HDMI type.

11. A method for enhancing video content transmitted from an audio/video content data source to a television set via a multifunction device comprising an input for receiving audio/video data from an audio/video content data source, an output for outputting audio/video data to a display device, communication means for accessing Internet or a local area network for collecting additional data, and a common interface powering and connecting the multifunction device to the display device, the method comprises steps of:
receiving at the input of the multifunction device first image data,
receiving additional data from Internet or a local area network by an image merging module of said multifunction device,
converting the additional data into additional image data,
combining said additional image data with all or part of the first image data to obtain second image data,
forwarding the second image data to the output connected to the display device.

12. Method according to claim 11, wherein the image data comprise non-compressed data including frames and raw picture data ready to form images on a screen of the display device.

13. The method according to claim 12 further comprising a step of compressing by an image compression module the second image data before forwarding to the output.

14. The method according to claim 12 further comprising a step of decrypting the audio/video data entering at the input with a secret key previously received and stored in a memory of the multifunction device.

15. A multifunction device for television set to enhance video content comprising an input for receiving audio/video data from an audio/video content data source, an output for outputting audio/video data to a display device, and communication means for accessing Internet or a local area network for collecting additional data, the multifunction device being connected and powered by a common interface of the display device further comprises
an input converter configured for receiving first image data from the audio/video content data source and for converting said first image data into first input image data having a suitable format,
a converter configured for receiving additional data from Internet or a local area network and for converting said additional data into additional image data,
an image merging module configured for combining said additional image data with all or part of the converted input first image data to obtain second image data to be forwarded to the output connected to the display device.
